(19) United States
(12) Patent Application Publication
(10) Pub. No.: US 2023/0421325 A1
(43) Pub. Date: Dec. 28, 2023

(54) RADIO UNIT, DIGITAL UNIT, SYSTEM, AND METHOD FOR POSITIONING

(71) Applicant: Telefonaktiebolaget LM Ericsson (publ), Stockholm (SE)

(72) Inventors: Huaisong Zhu, Beijing (CN); Zhan Zhang, Beijing (CN); Ming Li, Stockholm (SE)

(21) Appl. No.: 18/037,132

(22) PCT Filed: Nov. 19, 2020
(86) PCT No.: PCT/CN2020/129968

§ 371 Date: May 16, 2023

(51) Int. Cl. H04L 5/00; G01S 5/02; G01S 5/00

(52) U.S. Cl. CPC H04L 5/0051; H04L 5/0053; G01S 5/02213; G01S 5/0081

(57) ABSTRACT

The present disclosure, a method performed by a Radio Unit, RU, is provided. The method includes: receiving, from a Digital Unit, DU, an instruction to receive a reference signal; receiving, from a terminal device, the reference signal in accordance with the instruction; and transmitting, to the DU, a positioning signal based on the received reference signal.

### TECHNICAL FIELD

The present disclosure relates to wireless communication, and more particularly, to a Radio Unit (RU), a Digital Unit (DU), a system, and a method for positioning.

### BACKGROUND

As part of the efforts to explore new use cases, the manufacturing industry is identified as one important use case, and high-accuracy positioning is desired in local indoor manufacturing environments.

In outdoor environments, which are common for industrial sites consisting of a campus with several buildings, Global Navigation Satellite System (GNSS), Beidou system, or Real Time Kinematic (RTK) system is available as a solution for providing high-accuracy positioning. However, cellular positioning is of high interest in indoor scenarios, as there may be no availability of satellite services or RTK capable devices.

For cellular positioning, it is important to achieve sufficiently good network time synchronization accuracy to meet manufacturing positioning requirements if the positioning method is based on Time-Difference-Of-Arrival (TDOA) methods. This is a very important aspect for high-accuracy indoor positioning. However, the main drawback with the TDOA-based methods is the need for accurate network synchronization, which in many cases is the limiting factor for the achievable positioning accuracy.

FIG. 1 shows an exemplary architecture of an RU 100. In the 5^{th} Generation (5G) New Radio (NR) for example, a typical configuration of an RU, even for indoor coverage, has a number (e.g., four) of radio transmitting/receiving paths, shown as 111˜11N, each including an Intermediate Frequency (IF) digital signal processor, a Digital-to-Analog Converter (DAC) or an Analog-to-Digital Converter (ADC), a Power Amplifier (PA) or a Low Noise Amplifier (LNA), a filter, and an antenna. In addition, the RU 100 is also equipped with a timing unit 120, a Multiple Input Multiple Output (MIMO) digital processor 130, and a front-haul interface 140 for communicating with a DU.

There is ongoing development on Long Term Evolution (LTE) positioning systems, e.g., Ericsson's Radio Dot System (RDS). The RDS can be divided into two parts:
A basic positioning part, targeting 5˜7 m positioning accuracy using Uplink (UL) Received Signal Strength Indication (RSSI) measurements, which can be further optimized with fingerprint shapefiles generated using e.g., Ericsson Indoor Planner (EIP).
An advanced positioning part, targeting 1˜3 m absolute positioning accuracy and 5 cm relative User Equipment (UE) to UE positioning accuracy with the help of minimizing dot-to-dot relative timing error and UL-TDOA based positioning.

Compared with LTE, the 5G, with increased bandwidth, increased comb factor and increased number of symbols that can be configured for reference signals used for positioning in Release 16 (Downlink (DL) Primary Reference Signal (PRS) and UL Sounding Reference Signal (SRS)), gives a large performance gain in TOA estimation accuracy. Unfortunately, even with these features, existing indoor radio systems are still not capable of providing high-accuracy positioning in manufacturing scenarios, since these scenarios normally need absolute accuracy at centimeter level, which is very challenging.

The positioning accuracy is sensitive to base station synchronization uncertainty. Network synchronization is very important for DL-TDOA as well as UL-TDOA. Network synchronization uncertainty usually leads to errors in the TDOA estimates, and may dominate the overall positioning error. The synchronization uncertainty can be translated into positioning uncertainty by considering the distance light travels during the timing error caused by the synchronization uncertainty. In this sense, a synchronization error of 1 ns corresponds to a positioning error of 0.3 m. The actual positioning error depends however also on the system deployment and the positioning algorithm used, but this translation can be used as an estimate.

For most commercial base stations, at maximum 10˜30 ns synchronization accuracy (3˜10 m positioning error component) can be achieved. With hardware and software efforts, synchronization accuracy of a few nanoseconds (˜1 m positioning error component) may be achieved but with high component cost and development efforts. Synchronization accuracy of around 1 ns (˜30 cm positioning error component) seems possible but challenging and costly to achieve. Note that the synchronization accuracy numbers presented here are indicative and that the positioning accuracy numbers indicate positioning uncertainty due to synchronization uncertainty only. The actual positioning accuracy may also depend on the performance of the positioning method used.

The positioning accuracy is also sensitive to frequency errors. Frequency errors over time produces a drift. When designing positioning schemes between a base station, e.g., a (next) generation NodeB (gNB) and a UE, it is essential to reduce the time difference between various measurements. One added benefit is that the channel is likely to remain the same.

The 3^{rd} Generation Partnership Project (3GPP) requirements on frequency errors cover a clock accuracy requirement as well as a constant offset between a receiving chain and a transmitting chain due to implementations. The 3GPP requirement on frequency errors for base stations, a 50 ns difference, is not tight enough to achieve high-accuracy positioning.

The positioning accuracy is also sensitive to the multipath effect. The TOA estimation will be affected by multipath propagation in industrial scenarios. The severity of the error depends on the amplitude and the delay of the multipath component as well as on the algorithms used in the cross-correlation process. The amplitude of the error will depend on whether the multipath component has a shorter or longer delay compared to the Line of Sight (LoS) component. In case of a short delay multipath, the LoS peak and the multipath peak of the cross-correlation magnitude will be superimposed, which will cause a relatively small multipath error. The resulting ToA error might be either positive or negative, depending on whether the multipath component interferes constructively or destructively. In case of a long delay multipath, the main peak of the multipath component can in principle be filtered out, but if it is mistaken for the LoS component, the multipath error might be very large. It is thus of importance to the performance of the positioning system to be able to detect if a detected peak corresponds to a LoS or a Non-LoS (NLoS) component.

The multipath error decreases as the bandwidth increases. However, there is a persistent error also for the longer delays, due to sidelobes of correlation waveforms caused by the multipath component affecting the LoS component. The possibility to increase the bandwidth can provide a significant improvement.

The positioning accuracy is also sensitive to filter in-band flatness. Large sidelobes of filters (channel filter or analog filter) which are designed to reduce out-of-band emissions may create positioning errors, since UEs may mistake sidelobes for additional taps.

In summary, in order to achieve high-accuracy positioning, the following is desired:
Higher bandwidth for reference signal transmission/receiving;
More accurate base station timing (30× to 50× better than current products);
More LOSs (since we could not change air environment, normally operators will increase the density of radios in the deployment to make LOS more common); and
Flatter filter in-band characteristics.

On the other hand, current base stations, which are designed for Mobile Broad Band (MBB) traffic, tend to:
Support high transmission power to guarantee coverage, meaning limited bandwidth (higher bandwidth will reduce the power efficiency of radio components and cause high power consumption and heat issue.
Reduce capital expenditures (CAPEX) and operational expenditures (OPEX):
   Each radio should serve for more area, which means NLoS is inevitable.
   Each radio should control its component cost, which means highly accurate timing will not be achievable.

Therefore, it is difficult for today's cellular system to fulfill the requirements for high-accuracy positioning, especially in indoor environments.

### SUMMARY

It is an object of the present disclosure to provide an RU, a DU, a system, and a method for positioning, capable of achieving high-accuracy positioning, even in indoor environments.

According to a first aspect of the present disclosure, a method performed by an RU is provided. The method includes: receiving, from a DU, an instruction to receive a reference signal; receiving, from a terminal device, the reference signal in accordance with the instruction; and transmitting, to the DU, a positioning signal based on the received reference signal.

In an embodiment, the method may further include: determining an absolute position of the RU, or a relative position of the RU in relation to another RU; and transmitting the absolute position or relative position of the RU to the DU.

In an embodiment, the absolute position of the RU may be determined by means of satellite-based positioning.

In an embodiment, the relative position of the RU may be determined by means of one or more of: laser positioning, path-loss measurement, or time-difference measurement, between the RU and the other RU.

In an embodiment, the method may further include: determining an absolute position of another RU, or a relative position of the other RU in relation to the RU; and transmitting the absolute position or relative position of the other RU to the other RU to the DU.

In an embodiment, the positioning signal may indicate one or more of: time at which the reference signal is received at the RU, and/or an amplitude and a phase of the received reference signal.

In an embodiment, the method may further include: transmitting, to a further RU, a request for a configuration of the reference signal; and receiving the configuration from the further RU.

In an embodiment, the method may further include: transmitting, to a further RU, a configuration of the reference signal.

In an embodiment, the configuration may include a timing and/or a radio resource for the reference signal.

In an embodiment, the further RU may be configured for data communication and associated signaling, and the RU may be dedicated to positioning.

According to a second aspect of the present disclosure, a method performed by a DU is provided. The method includes: transmitting, to an RU, an instruction to receive a reference signal; transmitting, to a terminal device via a further RU, an instruction to transmit the reference signal; receiving, from the RU, a positioning signal based on the received reference signal; and determining a position of the terminal device based on the positioning signal.

In an embodiment, the method may further include: receiving, from the RU, an absolute position of the RU, or a relative position of the RU in relation to another RU.

In an embodiment, the position of the terminal device may be determined further based on the absolute position or relative position of the RU.

In an embodiment, the method may further include: receiving, from the RU, an absolute position of another RU, or a relative position of the other RU in relation to the RU.

In an embodiment, the positioning signal may indicate one or more of: time at which the reference signal is received at the RU, and/or an amplitude and a phase of the received reference signal.

In an embodiment, the method may further include: forwarding a request for a configuration of the reference signal from the RU to the further RU; and forwarding the configuration from the further RU to the RU.

In an embodiment, the method may further include: forwarding a configuration of the reference signal from the RU to the further RU.

In an embodiment, the configuration may include a timing and/or a radio resource for the reference signal.

In an embodiment, the method may further include: transmitting, to the further RU, information indicating the determined position of the terminal device.

In an embodiment, the further RU may be configured for data communication and associated signaling, and the RU may be dedicated to positioning.

According to a third aspect of the present disclosure, a method performed by an RU is provided. The method includes: receiving, from a DU, an instruction to transmit a reference signal; and transmitting, to a terminal device, the reference signal in accordance with the instruction.

In an embodiment, the method may further include: determining an absolute position of the RU, or a relative position of the RU in relation to another RU; and transmitting the absolute position or relative position of the RU to the DU.

In an embodiment, the absolute position of the RU may be determined by means of satellite-based positioning.

In an embodiment, the relative position of the RU may be determined by means of one or more of: laser positioning, path-loss measurement, or time-difference measurement, between the RU and the other RU.

In an embodiment, the method may further include: determining an absolute position of another RU, or a relative position of the other RU in relation to the RU; and transmitting the absolute position or relative position of the other RU to the other RU to the DU.

In an embodiment, the method may further include: receiving, from the terminal device, information indicating a position of the terminal device; and transmitting the information to the DU.

In an embodiment, the method may further include: receiving, from the DU or a further RU, a configuration of the reference signal.

In an embodiment, the method may further include: transmitting, to the DU or a further RU, a configuration of the reference signal.

In an embodiment, the configuration may include a timing and/or a radio resource for the reference signal.

In an embodiment, the further RU may be configured for data communication and associated signaling, and the RU may be dedicated to positioning.

According to a fourth aspect of the present disclosure, a method performed by a DU is provided. The method includes: transmitting, to an RU, an instruction to transmit a reference signal; transmitting, to a terminal device via a further RU, an instruction to receive the reference signal; and receiving, from the RU or the further RU, information indicating a position of the terminal device.

In an embodiment, the method may further include: forwarding a request for a configuration of the reference signal from the RU to the further RU; and forwarding the configuration from the further RU to the RU.

In an embodiment, the method may further include: forwarding a configuration of the reference signal from the RU to the further RU.

In an embodiment, the configuration may include a timing and/or a radio resource for the reference signal.

In an embodiment, the method may further include: transmitting the information to the further RU.

In an embodiment, the further RU may be configured for data communication and associated signaling, and the RU may be dedicated to positioning.

According to a fifth aspect of the present disclosure, an RU is provided. The RU includes a processor and a memory. The memory contains instructions executable by the processor whereby the RU is operative to perform the method according to the above first or third aspect.

According to a sixth aspect of the present disclosure, a computer readable storage medium is provided. The computer readable storage medium has computer program instructions stored thereon. The computer program instructions, when executed by a processor in an RU, cause the RU to perform the method according to the above first or third aspect.

According to a seventh aspect of the present disclosure, a DU is provided. The DU includes a processor and a memory. The memory contains instructions executable by the processor whereby the DU is operative to perform the method according to the above second or fourth aspect.

According to an eighth aspect of the present disclosure, a computer readable storage medium is provided. The computer readable storage medium has computer program instructions stored thereon. The computer program instructions, when executed by a processor in a DU, cause the DU to perform the method according to the above second or fourth aspect.

According to a ninth aspect of the present disclosure, a system is provided. The system includes an RU according to the above fifth aspect; a DU according to the above seventh aspect; and a further RU configured for data communication and associated signaling.

In an embodiment, the further RU may be dedicated to data communication and associated signaling.

According to a tenth aspect of the present disclosure, an RU dedicated to positioning is provided. The RU includes: a self-positioning circuit configured to determine a position of the RU; a front-haul interface configured to receive, from a DU, an instruction to transmit or receive a reference signal; and a transceiver configured to transmit or receive the reference signal to or from a terminal device.

In an embodiment, the front-haul interface may be further configured to transmit, to the DU, a positioning signal based on the reference signal received by the transceiver.

In an embodiment, the transceiver may be configured to, subsequent to transmitting the reference signal to the terminal device, receive, from the terminal device, information indicating a position of the terminal device; and the front-haul interface may be further configured to transmit the information to the DU.

According to an eleventh aspect of the present disclosure, a DU is provided. The DU includes: a front-haul interface configured to transmit, to an RU, an instruction to transmit or receive a reference signal.

In an embodiment, the front-haul interface may be further configured to receive, from the RU, a positioning signal based on the reference signal received by the RU.

According to a twelfth aspect of the present disclosure, a system is provided. The system includes: a DU according to the above eleventh aspect; an RU according to the above tenth aspect; and a further RU configured for data communication and associated signaling.

In an embodiment the further RU may be dedicated to data communication and associated signaling.

With the embodiments of the present disclosure, an RU can receive from a DU an instruction to transmit or receive a reference signal, and transmit or receive the reference signal to or from a terminal device in accordance with the instruction. The RU can transmit to the DU a positioning signal based on the received reference signal. Alternatively, the RU can receive, from the terminal device, information indicating a position of the terminal device, and transmit the information to the DU. This RU can be dedicated to positioning, i.e., it is not configured for, or not capable of, data communication and associated signaling. Such RU can achieve high-accuracy positioning, even in indoor environments, with high efficiency and low costs.

### BRIEF DESCRIPTION OF THE DRAWINGS

The above and other objects, features and advantages will be more apparent from the following description of embodiments with reference to the figures, in which:

FIG. 1 is a schematic diagram showing an exemplary architecture of an RU;

FIG. 2 is a schematic diagram showing an exemplary architecture of a Positioning RU (PRU) according to an embodiment of the present disclosure;

FIG. 3 is a block diagram of a DU according to an embodiment of the present disclosure;

FIG. 4 is a flowchart illustrating a method in a PRU according to an embodiment of the present disclosure;

FIG. 5 is a flowchart illustrating a method in a DU according to an embodiment of the present disclosure;

FIG. 6 is a flowchart illustrating a method in a PRU according to another embodiment of the present disclosure;

FIG. 7 is a flowchart illustrating a method in a DU according to another embodiment of the present disclosure;

FIG. 8 is a block diagram of an RU (PRU) according to an embodiment of the present disclosure;

FIG. 9 is a block diagram of a DU according to an embodiment of the present disclosure;

FIG. 10 is a block diagram of an RU (PRU) according to another embodiment of the present disclosure;

FIG. 11 is a block diagram of a DU according to another embodiment of the present disclosure;

FIG. 12 is a block diagram of an RU (PRU) according to yet another embodiment of the present disclosure;

FIG. 13 is a block diagram of a DU according to yet another embodiment of the present disclosure;

FIG. 14 is a schematic diagram showing an exemplary architecture of a system according to an embodiment of the present disclosure;

FIG. 15 schematically illustrates a telecommunication network connected via an intermediate network to a host computer;

FIG. 16 is a generalized block diagram of a host computer communicating via a base station with a user equipment over a partially wireless connection; and

FIGS. 17 to 20 are flowcharts illustrating methods implemented in a communication system including a host computer, a base station and a user equipment.

### DETAILED DESCRIPTION

As used herein, the term “wireless communication network” refers to a network following any suitable communication standards, such as NR, LTE-Advanced (LTE-A), LTE, Wideband Code Division Multiple Access (WCDMA), High-Speed Packet Access (HSPA), and so on. Furthermore, the communications between a terminal device and a network device in the wireless communication network may be performed according to any suitable generation communication protocols, including, but not limited to, Global System for Mobile Communications (GSM), Universal Mobile Telecommunications System (UMTS), Long Term Evolution (LTE), and/or other suitable 1G (the first generation), 2G (the second generation), 2.5G, 2.75G, 3G (the third generation), 4G (the fourth generation), 4.5G, 5G (the fifth generation) communication protocols, wireless local area network (WLAN) standards, such as the IEEE 802.11 standards; and/or any other appropriate wireless communication standard, such as the Worldwide Interoperability for Microwave Access (WiMax), Bluetooth, and/or ZigBee standards, and/or any other protocols either currently known or to be developed in the future.

The term “network device” refers to a device in a wireless communication network via which a terminal device accesses the network and receives services therefrom. The network device refers to a base station (BS), an access point (AP), or any other suitable device in the wireless communication network. The BS may be, for example, a node B (NodeB or NB), an evolved NodeB (eNodeB or eNB), or gNB, a Remote Radio Unit (RRU), a radio header (RH), a remote radio head (RRH), a relay, a low power node such as a femto, a pico, and so forth. Yet further examples of the network device may include multi-standard radio (MSR) radio equipment such as MSR BSs, network controllers such as radio network controllers (RNCs) or base station controllers (BSCs), base transceiver stations (BTSs), transmission points, transmission nodes. More generally, however, the network device may represent any suitable device (or group of devices) capable, configured, arranged, and/or operable to enable and/or provide a terminal device access to the wireless communication network or to provide some service to a terminal device that has accessed the wireless communication network.

The term “terminal device” refers to any end device that can access a wireless communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, portable computers, desktop computers, image capture terminal devices such as digital cameras, gaming terminal devices, music storage and playback appliances, a mobile phone, a cellular phone, a smart phone, voice over IP (VoIP) phones, wireless local loop phones, tablets, personal digital assistants (PDAs), wearable terminal devices, vehicle-mounted wireless terminal devices, wireless endpoints, mobile stations, laptop-embedded equipment (LEE), laptop-mounted equipment (LME), USB dongles, smart devices, wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3rd Generation Partnership Project (3GPP), such as 3GPP's GSM, UMTS, LTE, and/or 5G standards. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the wireless communication network. Instead, a UE may represent a device that is intended for sale to, or operation by, a human user but that may not initially be associated with a specific human user.

The terminal device may support device-to-device (D2D) communication, for example by implementing a 3GPP standard for sidelink communication, and may in this case be referred to as a D2D communication device.

As yet another example, in an Internet of Things (IOT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

As used herein, a downlink transmission refers to a transmission from a network device to a terminal device, and an uplink transmission refers to a transmission in an opposite direction.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

The terminology used herein is for the purpose of describing particular embodiments only and is not intended to be liming of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

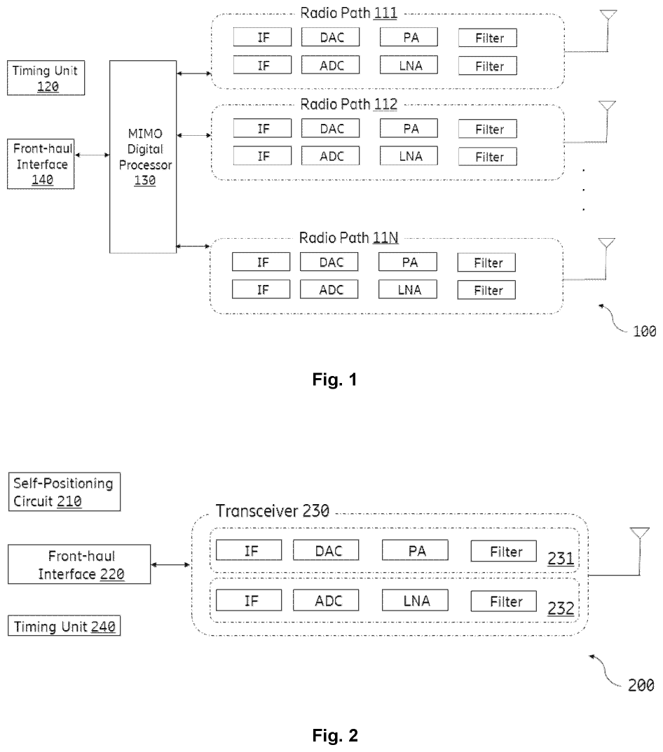

FIG. 2 is a schematic diagram showing an exemplary architecture of an RU 200 according to an embodiment of the present disclosure. The RU 200 may be dedicated to positioning, e.g., not configured for or not capable of data communication and associated signaling, and thus be referred to as Positioning RU (PRU) in this context as opposed to regular RUs that are configured for, or dedicated to, data communication and associated signaling.

As shown in FIG. 2, the PRU 200 includes a self-positioning circuit 210, a front-haul interface 220, and a transceiver 230. The RU 200 may further include an enhanced, high-accuracy timing unit 240.

The self-positioning circuit 210 is configured to determine a position of the PRU 200. For example, the self-positioning circuit 210 can be configured to determine an absolute position of the PRU 200, e.g., by means of satellite-based positioning such as Global Positioning System (GPS). Alternatively, the self-positioning circuit 210 can be configured to determine a relative position of the PRU 200 in relation to another RU, which can be a regular RU or another PRU, e.g., by means of one or more of: laser positioning, path-loss measurement, or time-difference measurement, between the PRU 200 and the other RU. The self-positioning circuit 210 may be further configured to calibrate a hardware impairment to reduce its introduced error.

The PRU 200, or in particular the front-haul interface 220, can have reduced front-haul processing capabilities as well as a much lower front-haul bandwidth and a lower traffic jitter requirement when compared with a regular RU. For example, the front-haul interface 220 may be a 1 Gbps optical interface, as compared to a 25˜50 Gbps optical interface for a regular NR RU. The front-haul interface 220 may be configured to receive, from a DU, an instruction to transmit or receive a reference signal (e.g., DL PRS or UL SRS).

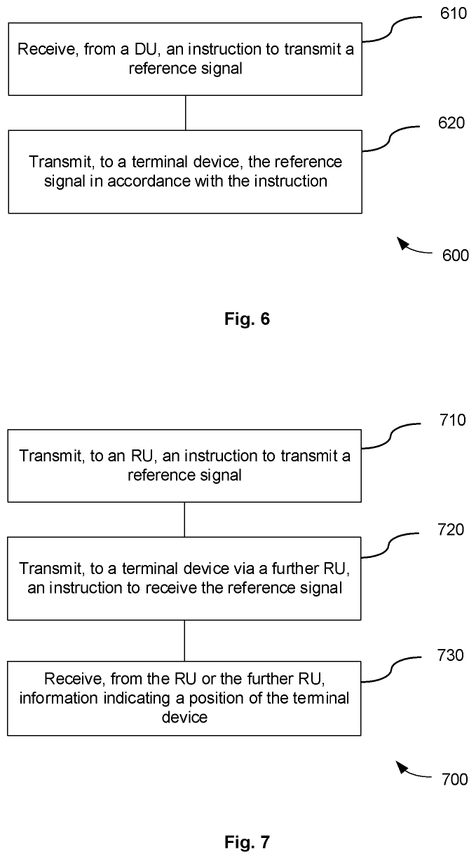

The transceiver 230 may include a branch 231 for DL positioning (e.g., as described hereinafter with reference to FIG. 6), including an IF digital signal processor, a DAC, a PA, and a filter, and/or a branch 232 for UL positioning (e.g., as described hereinafter with reference to FIG. 4), including an IF digital signal processor, an ADC, an LNA, and a filter. The transceiver 230 may be configured to transmit or receive the reference signal to or from a terminal device in accordance with the instruction from the DU.

In an example, the front-haul interface 220 can be further configured to transmit, to the DU, a positioning signal based on the reference signal received by the transceiver 230. For example, the positioning signal may indicate one or more of: time at which the reference signal is received at the PRU 200, and/or an amplitude and a phase of the received reference signal.

Alternatively, the transceiver 230 can be configured to, subsequent to transmitting the reference signal to the terminal device, receive, from the terminal device, information indicating a position of the terminal device. The front-haul interface 220 can be further configured to transmit the information to the DU.

The PRU 200 may differ from a regular RU in the following aspects:
Advanced self-positioning function
   The PRU 200 can be provided with a high-accuracy self-positioning function (e.g., satellite-based positioning or laser-positioning).
High accuracy timing function
   The PRU 200 can be provided with a high accuracy timing function, e.g., at timing accuracy at ns level, for synchronization between a network synchronization source and the PRU 200. A higher sampling rate can be applied to decrease an impact of timing error from samples.
Reduced air-interface function
   The PRU 200 can have reduced or even no data communication or associated signaling function, but only with a positioning signaling function. All Radio Frequency (RF) or digital components related to data communication or associated signaling may be reduced or removed. In particular, the PRU 200 may have:
      Low transmission power or bandwidth,
      Extremely low Peak-to-Average Ratio (PAR), which means an extremely low complexity and cost,
      Extremely low out-of-band filtering requirement, which means a low cost filter or no filter, and
      No stringent requirement on switching timing between DL and UL.
Wider dynamic receiving range in signal reception to allow positioning radios to be placed closer to terminal devices
Minimized front-haul data exchange/processing capability
   The PRU 200 can have a much lower front-haul bandwidth and a low traffic jilter requirement when compared with a regular RU. The PRU 200 can have minimized front-haul processing capability, e.g., a 1 Gbps optical interface as compared to a 25˜50 Gbps optical interface for a regular NR RU.
Reduced MIMO related processing capability
   The PRU 200 may have reduced or even no MIMO processing capability or beamforming capability, e.g., having typically one single radio path.
Measurement or transmission functionality for signals outside data transmission bands or in non-license bands.

The PRU 200 may be further provided with functions for coordinating with other PRUs and/or regular RUs connected to the same DU. For example, the PRU 200 may be provided with PRU-to-PRU interfaces and control protocols, and/or PRU-to-regular-RU interfaces and control protocols.

With the above architecture, a total cost of such PRU 200 can be significantly reduced when compared to a regular RU, e.g., the PRU 200 can achieve a 30% of component cost reduction compared with a regular 5G NR 4TRX (transmitting/receiving) indoor RU. In addition, the PRU 200 may have a targeted power consumption which is only 10% to 5% of that of a regular 5G NR 4TRX indoor RU.

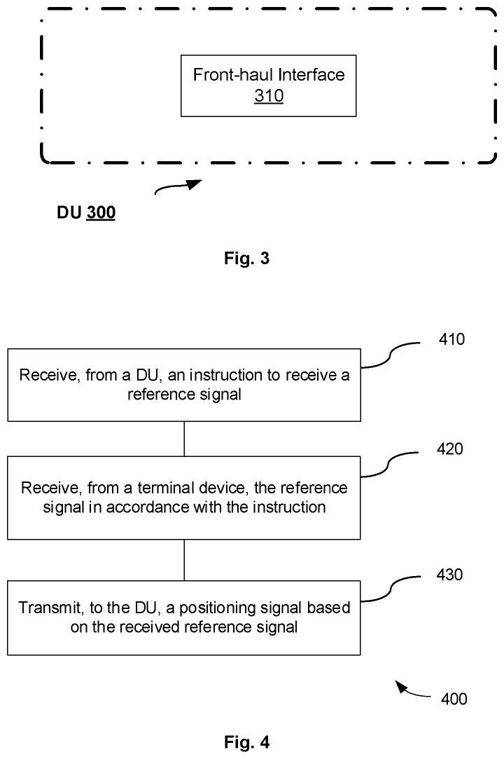

FIG. 3 is a block diagram of a DU 300 according to an embodiment of the present disclosure. The DU 300 includes a front-haul interface 310 configured to transmit, to a PRU (e.g., the PRU 200 as described above in connection with FIG. 2), an instruction to transmit or receive a reference signal.

The front-haul interface 310 can be further configured to receive, from the PRU, a positioning signal based on the reference signal received by the PRU. Alternatively, the front-haul interface 310 can be further configured to receive, from the PRU, information indicating a position of a terminal device. Here, the information can be received by the PRU from the terminal device as a response to the reference signal transmitted to the terminal device.

The DU 300 may include a positioning coordination function for coordinating positioning related information between PRUs or between a PRU and a regular RU. For example, the DU 300, or particularly the front-haul interface 310, may be configured to forward a request for a configuration of the reference signal from the PRU to a regular RU, and forward the configuration from the regular RU to the PRU. Alternatively, the DU 300, or particularly the front-haul interface 310, may be configured to forward a configuration of the reference signal from the PRU to a regular RU. Here, the configuration may include a timing and/or a radio resource for the reference signal.

FIG. 4 is a flowchart illustrating a method 400 according to an embodiment of the present disclosure. The method 400 can be performed by an RU, e.g., a PRU as described above.

At block 410, an instruction to receive a reference signal is received from a DU.

At block 420, the reference signal is received from a terminal device in accordance with the instruction. Here, the reference signal may be e.g., a UL SRS.

At block 430, a positioning signal based on the received reference signal is transmitted to the DU. For example, the positioning signal may indicate one or more of: time at which the reference signal is received at the RU, and/or an amplitude and a phase of the received reference signal.

In an example, the RU may determine an absolute position of the RU, e.g., by means of satellite-based positioning such as GPS. Alternatively, the RU may determine a relative position of the RU in relation to another RU (which may be a PRU or a regular RU), e.g., by means of one or more of: laser positioning, path-loss measurement, or time-difference measurement, between the RU and the other RU. The RU may then transmit the absolute position or relative position of the RU to the DU.

For example, in a system, a PRU may serve as a master PRU whose position is determined by a non-radio method, e.g., by means of field measurement or satellite-based positioning such as GPS, and other PRUs may determine their relative positions in relation to the master PRU. The master PRU may for example transmit a reference signal to each of the other PRUs, which may measure the reference signal to determine its own position based on such measurement. The measurement may be performed periodically to calibrate hardware fast-changing timing errors and/or frequency errors. With these advanced positioning methods, the PRU can obtain its own position at cm level or even more accurately.

In an example, the RU may determine an absolute position of another RU (which may be a PRU or a regular RU), or a relative position of the other RU in relation to the RU, and transmit the absolute position or relative position of the other RU to the other RU to the DU.

In an example, a PRU may utilize a regular RU's control of reference signals (e.g., SRSs). In particular, the RU may transmit, to a further RU (e.g., a regular RU), a request for a configuration of the reference signal and receive the configuration from the further RU. Alternatively, the RU may transmit, to a further RU (e.g., a regular RU), a configuration of the reference signal. Here, the configuration may include a timing and/or a radio resource for the reference signal.

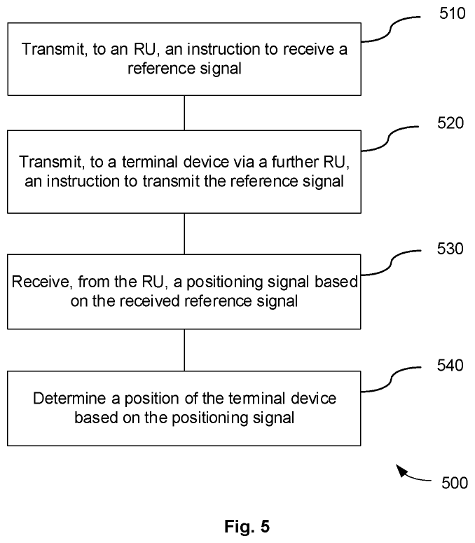

FIG. 5 is a flowchart illustrating a method 500 according to an embodiment of the present disclosure. The method 500 can be performed by e.g., a DU.

At block 510, an instruction to receive a reference signal is transmitted to an RU (e.g., a PRU as described above).

At block 520, an instruction to transmit the reference signal is transmitted to a terminal device via a further RU (e.g., a regular RU).

At block 530, a positioning signal based on the received reference signal is received from the RU. For example, the positioning signal may indicate one or more of: time at which the reference signal is received at the RU, and/or an amplitude and a phase of the received reference signal.

At block 540, a position of the terminal device is determined based on the positioning signal.

In an example, the DU may receive, from the RU, an absolute position of the RU, or a relative position of the RU in relation to another RU (which may be a PRU or a regular RU). In the block 540, the position of the terminal device can be determined further based on the absolute position or relative position of the RU.

In an example, the DU may forward a request for a configuration of the reference signal from the RU to the further RU, and forward the configuration from the further RU to the RU. Alternatively, the DU may forward a configuration of the reference signal from the RU to the further RU. The configuration may include a timing and/or a radio resource for the reference signal.

FIG. 6 is a flowchart illustrating a method 600 according to an embodiment of the present disclosure. The method 600 can be performed by e.g., a PRU as described above.

At block 610, an instruction to transmit a reference signal is received from a DU.

At block 620, the reference signal is transmitted to a terminal device in accordance with the instruction. Here, the reference signal may be e.g., a DL PRS.

In an example, the RU may determine an absolute position of the RU, e.g., by means of satellite-based positioning such as GPS. Alternatively, the RU may determine a relative position of the RU in relation to another RU (which may be a PRU or a regular RU), e.g., by means of one or more of: laser positioning, path-loss measurement, or time-difference measurement, between the RU and the other RU. The RU may then transmit the absolute position or relative position of the RU to the DU.

In an example, the RU may determine an absolute position of another RU (which may be a PRU or a regular RU), or a relative position of the other RU in relation to the RU, and transmit the absolute position or relative position of the other RU to the other RU to the DU.

In an example, the RU may receive, from the terminal device, information indicating a position of the terminal device, and transmit the information to the DU.

In an example, the RU may receive, from the DU or a further RU (e.g., a regular RU), a configuration of the reference signal. Alternatively, the RU may transmit, to the DU or a further RU (e.g., a regular RU), a configuration of the reference signal.

The configuration may include a timing and/or a radio resource for the reference signal.

FIG. 7 is a flowchart illustrating a method 700 according to an embodiment of the present disclosure. The method 700 can be performed by e.g., a DU.

At block 710, an instruction to transmit a reference signal is transmitted to an RU (e.g., a PRU as described above).

At block 720, an instruction to receive the reference signal is transmitted to a terminal device via a further RU (e.g., a regular RU).

At block 730, information indicating a position of the terminal device is received from the RU or the further RU.

In an example, the DU may forward a request for a configuration of the reference signal from the RU to the further RU, and forward the configuration from the further RU to the RU. Alternatively, the DU may forward a configuration of the reference signal from the RU to the further RU. Here, the configuration may include a timing and/or a radio resource for the reference signal.

In an example, e.g., when the information is received from the RU in the block 730, the DU may transmit the information to the further RU.

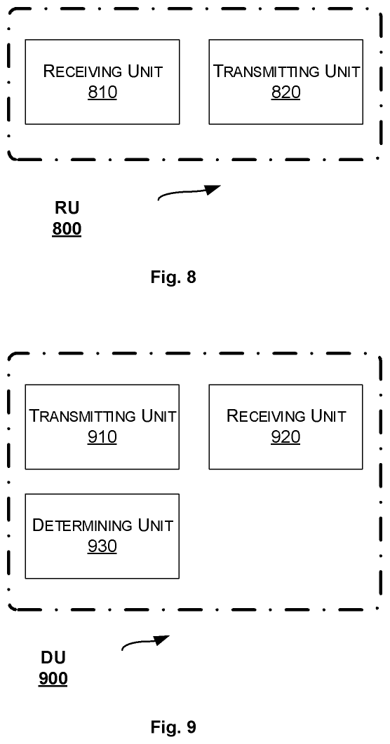

Correspondingly to the method 400 as described above, an RU is provided. FIG. 8 is a block diagram of an RU 800 according to an embodiment of the present disclosure. The RU 800 can be a PRU as described above.

As shown in FIG. 8, the RU 800 includes a receiving unit 810 configured to: receive, from a DU, an instruction to receive a reference signal; and receive, from a terminal device, the reference signal in accordance with the instruction. The RU 800 further includes a transmitting unit 820 configured to transmit, to the DU, a positioning signal based on the received reference signal.

In an embodiment, the RU 800 may further include a determining unit configured to determine an absolute position of the RU, or a relative position of the RU in relation to another RU. The transmitting unit 820 may be further configured to transmit the absolute position or relative position of the RU to the DU.

In an embodiment, the absolute position of the RU may be determined by means of satellite-based positioning.

In an embodiment, the relative position of the RU may be determined by means of one or more of: laser positioning, path-loss measurement, or time-difference measurement, between the RU and the other RU.

In an embodiment, the RU 800 may further include a determining unit configured to determine an absolute position of another RU, or a relative position of the other RU in relation to the RU. The transmitting unit 820 may be further configured to transmit the absolute position or relative position of the other RU to the other RU to the DU.

In an embodiment, the positioning signal may indicate one or more of: time at which the reference signal is received at the RU, and/or an amplitude and a phase of the received reference signal.

In an embodiment, the transmitting unit 820 may be further configured to transmit, to a further RU, a request for a configuration of the reference signal; and receiving the configuration from the further RU.

In an embodiment, the transmitting unit 820 may be further configured to transmit, to a further RU, a configuration of the reference signal.

In an embodiment, the configuration may include a timing and/or a radio resource for the reference signal.

In an embodiment, the further RU may be configured for data communication and associated signaling, and the RU may be dedicated to positioning.

The receiving unit 810 and the transmitting unit 820 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 4.

Correspondingly to the method 500 as described above, a DU is provided. FIG. 9 is a block diagram of a DU 900 according to an embodiment of the present disclosure.

As shown in FIG. 9, the DU 900 includes a transmitting unit 910 configured to: transmit, to an RU, an instruction to receive a reference signal; and transmit, to a terminal device via a further RU, an instruction to transmit the reference signal. The DU 900 further includes a receiving unit 920 configured to receive, from the RU, a positioning signal based on the received reference signal. The DU 900 further includes a determining unit 930 configured to determine a position of the terminal device based on the positioning signal.

In an embodiment, the receiving unit 920 may be further configured to receive, from the RU, an absolute position of the RU, or a relative position of the RU in relation to another RU.

In an embodiment, the position of the terminal device may be determined further based on the absolute position or relative position of the RU.

In an embodiment, the receiving unit 920 may be further configured to receive, from the RU, an absolute position of another RU, or a relative position of the other RU in relation to the RU.

In an embodiment, the positioning signal may indicate one or more of: time at which the reference signal is received at the RU, and/or an amplitude and a phase of the received reference signal.

In an embodiment, the transmitting unit 910 may be further configured to: forward a request for a configuration of the reference signal from the RU to the further RU; and forward the configuration from the further RU to the RU.

In an embodiment, the transmitting unit 910 may be further configured to forward a configuration of the reference signal from the RU to the further RU.

In an embodiment, the configuration may include a timing and/or a radio resource for the reference signal.

In an embodiment, the transmitting unit 910 may be further configured to transmit, to the further RU, information indicating the determined position of the terminal device.

In an embodiment, the further RU may be configured for data communication and associated signaling, and the RU may be dedicated to positioning.

The transmitting unit 910, the receiving unit 920, and the determining unit 930 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 5.

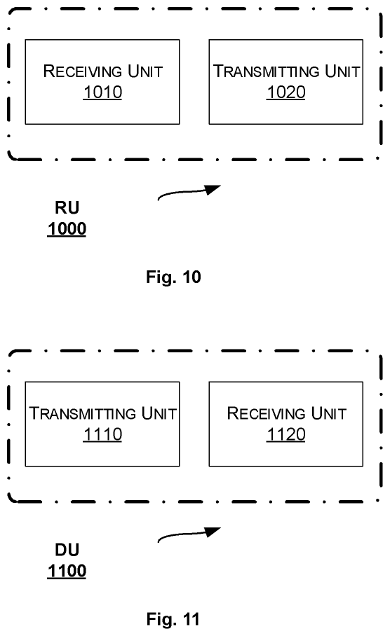

Correspondingly to the method 600 as described above, an RU is provided. FIG. 10 is a block diagram of an RU 1000 according to another embodiment of the present disclosure. The RU 1000 can be a PRU as described above.

As shown in FIG. 10, the RU 1000 includes a receiving unit 1010 configured to receive, from a DU, an instruction to transmit a reference signal. The RU 1000 further includes a transmitting unit 1020 configured to transmit, to a terminal device, the reference signal in accordance with the instruction.

In an embodiment, the RU 1000 may further include a determining unit configured to determine an absolute position of the RU, or a relative position of the RU in relation to another RU. The transmitting unit 1020 may be further configured to transmit the absolute position or relative position of the RU to the DU.

In an embodiment, the absolute position of the RU may be determined by means of satellite-based positioning.

In an embodiment, the relative position of the RU may be determined by means of one or more of: laser positioning, path-loss measurement, or time-difference measurement, between the RU and the other RU.

In an embodiment, the RU 1000 may further include a determining unit configured to determine an absolute position of another RU, or a relative position of the other RU in relation to the RU. The transmitting unit 1020 may be further configured to transmit the absolute position or relative position of the other RU to the other RU to the DU.

In an embodiment, the receiving unit 1010 may be further configured to receive, from the terminal device, information indicating a position of the terminal device. The transmitting unit 1020 may be further configured to transmit the information to the DU.

In an embodiment, the receiving unit 1010 may be further configured to receive, from the DU or a further RU, a configuration of the reference signal.

In an embodiment, the transmitting unit 1020 may be further configured to transmit, to the DU or a further RU, a configuration of the reference signal.

In an embodiment, the configuration may include a timing and/or a radio resource for the reference signal.

In an embodiment, the further RU may be configured for data communication and associated signaling, and the RU may be dedicated to positioning.

The receiving unit 1010 and the transmitting unit 1020 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 6.

Correspondingly to the method 700 as described above, a DU is provided. FIG. 11 is a block diagram of a DU 1100 according to another embodiment of the present disclosure.

As shown in FIG. 11, the DU 1100 includes a transmitting unit 1110 configured to: transmit, to an RU, an instruction to transmit a reference signal; and transmit, to a terminal device via a further RU, an instruction to receive the reference signal. The DU 1000 further includes a receiving unit 1120 configured to receive, from the RU or the further RU, information indicating a position of the terminal device.

In an embodiment, the transmitting unit 1110 may be further configured to: forward a request for a configuration of the reference signal from the RU to the further RU; and forward the configuration from the further RU to the RU.

In an embodiment, the transmitting unit 1110 may be further configured to: forward a configuration of the reference signal from the RU to the further RU.

In an embodiment, the configuration may include a timing and/or a radio resource for the reference signal.

In an embodiment, the transmitting unit 1110 may be further configured to transmit the information to the further RU.

In an embodiment, the further RU may be configured for data communication and associated signaling, and the RU may be dedicated to positioning.

The transmitting unit 1110 and the receiving unit 1120 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 7.

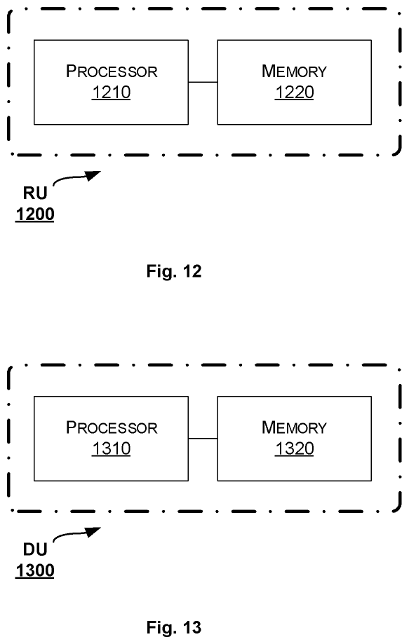

FIG. 12 is a block diagram of an RU 1200 according to yet another embodiment of the present disclosure. The RU 1200 can be a PRU as described above.

The RU 1200 includes a processor 1210 and a memory 1220. The memory 1220 can contain instructions executable by the processor 1210 whereby the RU 1200 is operative to perform the actions, e.g., of the procedure described earlier in conjunction with FIG. 4. Particularly, the memory 1220 contains instructions executable by the processor 1210 whereby the RU 1200 is operative to: receive, from a DU, an instruction to receive a reference signal; receive, from a terminal device, the reference signal in accordance with the instruction; and transmit, to the DU, a positioning signal based on the received reference signal.

In an embodiment, the memory 1220 may further contain instructions executable by the processor 1210 whereby the RU 1200 is operative to: determine an absolute position of the RU, or a relative position of the RU in relation to another RU; and transmit the absolute position or relative position of the RU to the DU.

In an embodiment, the absolute position of the RU may be determined by means of satellite-based positioning.

In an embodiment, the relative position of the RU may be determined by means of one or more of: laser positioning, path-loss measurement, or time-difference measurement, between the RU and the other RU.

In an embodiment, the memory 1220 may further contain instructions executable by the processor 1210 whereby the RU 1200 is operative to: determine an absolute position of another RU, or a relative position of the other RU in relation to the RU; and transmit the absolute position or relative position of the other RU to the other RU to the DU.

In an embodiment, the positioning signal may indicate one or more of: time at which the reference signal is received at the RU, and/or an amplitude and a phase of the received reference signal.

In an embodiment, the memory 1220 may further contain instructions executable by the processor 1210 whereby the RU 1200 is operative to: transmit, to a further RU, a request for a configuration of the reference signal; and receive the configuration from the further RU.

In an embodiment, the memory 1220 may further contain instructions executable by the processor 1210 whereby the RU 1200 is operative to: transmit, to a further RU, a configuration of the reference signal.

In an embodiment, the configuration may include a timing and/or a radio resource for the reference signal.

In an embodiment, the further RU may be configured for data communication and associated signaling, and the RU may be dedicated to positioning.

Alternatively, the memory 1220 can contain instructions executable by the processor 1210 whereby the RU 1200 is operative to perform the actions, e.g., of the procedure described earlier in conjunction with FIG. 6. Particularly, the memory 1220 contains instructions executable by the processor 1210 whereby the RU 1200 is operative to: receive, from a DU, an instruction to transmit a reference signal; and transmit, to a terminal device, the reference signal in accordance with the instruction.

In an embodiment, the memory 1220 may further contain instructions executable by the processor 1210 whereby the RU 1200 is operative to: determine an absolute position of the RU, or a relative position of the RU in relation to another RU; and transmit the absolute position or relative position of the RU to the DU.

In an embodiment, the absolute position of the RU may be determined by means of satellite-based positioning.

In an embodiment, the relative position of the RU may be determined by means of one or more of: laser positioning, path-loss measurement, or time-difference measurement, between the RU and the other RU.

In an embodiment, the memory 1220 may further contain instructions executable by the processor 1210 whereby the RU 1200 is operative to: determine an absolute position of another RU, or a relative position of the other RU in relation to the RU; and transmit the absolute position or relative position of the other RU to the other RU to the DU.

In an embodiment, the memory 1220 may further contain instructions executable by the processor 1210 whereby the RU 1200 is operative to: receive, from the terminal device, information indicating a position of the terminal device; and transmit the information to the DU.

In an embodiment, the memory 1220 may further contain instructions executable by the processor 1210 whereby the RU 1200 is operative to: receive, from the DU or a further RU, a configuration of the reference signal.

In an embodiment, the memory 1220 may further contain instructions executable by the processor 1210 whereby the RU 1200 is operative to: transmit, to the DU or a further RU, a configuration of the reference signal.

In an embodiment, the configuration may include a timing and/or a radio resource for the reference signal.

In an embodiment, the further RU may be configured for data communication and associated signaling, and the RU may be dedicated to positioning.

FIG. 13 is a block diagram of a DU 1300 according to yet another embodiment of the present disclosure.

The DU 1300 includes a processor 1310 and a memory 1320. The memory 1320 can contain instructions executable by the processor 1310 whereby the DU 1300 is operative to perform the actions, e.g., of the procedure described earlier in conjunction with FIG. 5. Particularly, the memory 1320 contains instructions executable by the processor 1310 whereby the DU 1300 is operative to: transmit, to an RU, an instruction to receive a reference signal; transmit, to a terminal device via a further RU, an instruction to transmit the reference signal; receive, from the RU, a positioning signal based on the received reference signal; and determine a position of the terminal device based on the positioning signal.

In an embodiment, the memory 1320 may contain instructions executable by the processor 1310 whereby the DU 1300 is operative to: receive, from the RU, an absolute position of the RU, or a relative position of the RU in relation to another RU.

In an embodiment, the position of the terminal device may be determined further based on the absolute position or relative position of the RU.

In an embodiment, the memory 1320 may contain instructions executable by the processor 1310 whereby the DU 1300 is operative to: receive, from the RU, an absolute position of another RU, or a relative position of the other RU in relation to the RU.

In an embodiment, the positioning signal may indicate one or more of: time at which the reference signal is received at the RU, and/or an amplitude and a phase of the received reference signal.

In an embodiment, the memory 1320 may contain instructions executable by the processor 1310 whereby the DU 1300 is operative to: forward a request for a configuration of the reference signal from the RU to the further RU; and forward the configuration from the further RU to the RU.

In an embodiment, the memory 1320 may contain instructions executable by the processor 1310 whereby the DU 1300 is operative to: forward a configuration of the reference signal from the RU to the further RU.

In an embodiment, the configuration may include a timing and/or a radio resource for the reference signal.

In an embodiment, the memory 1320 may contain instructions executable by the processor 1310 whereby the DU 1300 is operative to: transmit, to the further RU, information indicating the determined position of the terminal device.

In an embodiment, the further RU may be configured for data communication and associated signaling, and the RU may be dedicated to positioning.

The memory 1320 can contain instructions executable by the processor 1310 whereby the DU 1300 is operative to perform the actions, e.g., of the procedure described earlier in conjunction with FIG. 7. Particularly, the memory 1320 contains instructions executable by the processor 1310 whereby the DU 1300 is operative to: transmit, to an RU, an instruction to transmit a reference signal; transmit, to a terminal device via a further RU, an instruction to receive the reference signal; and receive, from the RU or the further RU, information indicating a position of the terminal device.

In an embodiment, the memory 1320 may contain instructions executable by the processor 1310 whereby the DU 1300 is operative to: forward a request for a configuration of the reference signal from the RU to the further RU; and forward the configuration from the further RU to the RU.

In an embodiment, the memory 1320 may contain instructions executable by the processor 1310 whereby the DU 1300 is operative to: forward a configuration of the reference signal from the RU to the further RU.

In an embodiment, the configuration may include a timing and/or a radio resource for the reference signal.

In an embodiment, the memory 1320 may contain instructions executable by the processor 1310 whereby the DU 1300 is operative to: transmit the information to the further RU.

In an embodiment, the further RU may be configured for data communication and associated signaling, and the RU may be dedicated to positioning.

The above methods 400 and 600 can also be performed by the PRU 200 as described in connection with FIG. 2. The above methods 500 and 700 can also be performed by the DU 300 as described in connection with FIG. 3.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes: code/computer readable instructions, which when executed by the processor 1210 causes the RU 1200 to perform the actions, e.g., of the procedure described earlier in conjunction with FIG. 4 or 6; or code/computer readable instructions, which when executed by the processor 1310 causes the DU 1300 to perform the actions, e.g., of the procedure described earlier in conjunction with FIG. 5 or 7.

The computer program product may be configured as a computer program code structured in computer program modules. The computer program modules could essentially perform the actions of the flow illustrated in FIG. 4, 5, 6, or 7.

The processor may be a single CPU (Central Processing Unit), but could also comprise two or more processing units. For example, the processor may include general purpose microprocessors; instruction set processors and/or related chips sets and/or special purpose microprocessors such as Application Specific Integrated Circuits (ASICs). The processor may also comprise board memory for caching purposes. The computer program may be carried by a computer program product connected to the processor. The computer program product may comprise a non-transitory computer readable storage medium on which the computer program is stored. For example, the computer program product may be a flash memory, a Random-Access Memory (RAM), a Read-Only Memory (ROM), or an EEPROM, and the computer program modules described above could in alternative embodiments be distributed on different computer program products in the form of memories.

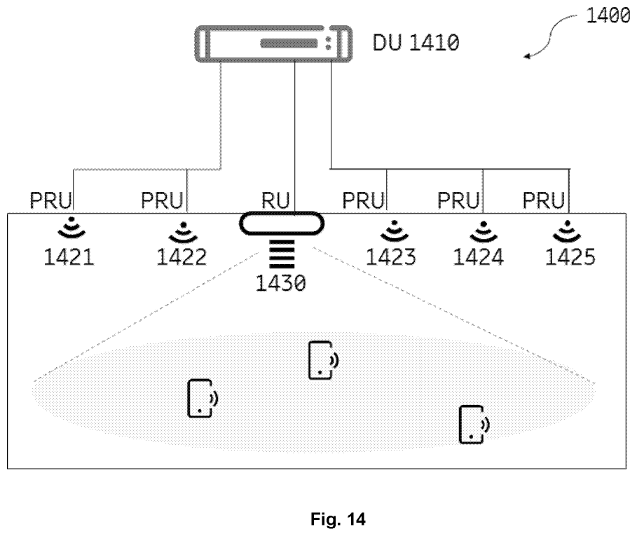

FIG. 14 is a schematic diagram showing an exemplary architecture of a system 1400 according to an embodiment of the present disclosure. The system 1400 includes a DU 1410, one or more PRUs 1421˜1425, and a regular RU 1430. The PRUs 1421˜1425 and the regular RU 1430 can be connected to the DU 1410.

In an example, the DU 1410 can be e.g., the DU 1300 as described above in connection with FIG. 13, and each of the PRUs 1421˜1425 can be e.g., the RU 1200 as described above in connection with FIG. 12. The regular RU 1430 can be configured for, or dedicated to, data communication and associated signaling. A number of UEs are shown as being served by the regular RU 1430.

In another example, the DU 1410 can be e.g., the DU 300 as described above in connection with FIG. 3, and each of the PRUs 1421˜1425 can be e.g., the RU 200 as described above in connection with FIG. 2. The regular RU 1430 can be configured for, or dedicated to, data communication and associated signaling.

In the system 1400, some 3GPP defined, positioning related air-interface signaling can be located in the regular RU 300, including e.g.:
UE UL signal information (timing and radio resource for transmitting UL signals),
Control of UL signal (e.g., SRS) transmission by UE, and
Management of UE status.

Information exchange between the PRUs 1421˜1425 or between any of the PRUs 1421˜1425 and the regular RU 1430 can be performed via the DU 1410.

For example, the DU 1410 may provide the regular RU 1430 with the UEs' positions, such that the regular RU 1430 may use the positions in:
Mobility (e.g., handover) decisions,
Estimation of channel information and/or mobility rate (e.g., timing/frequency synchronization or Doppler spread),
Beam management, and/or
Resource allocation between the PRUs 1421˜1425 and/or between any of the PRUs 1421˜1425 and the regular RU 1430, for interference avoidance or joint/cooperative/selective signal transmission/reception for higher positioning accuracy.

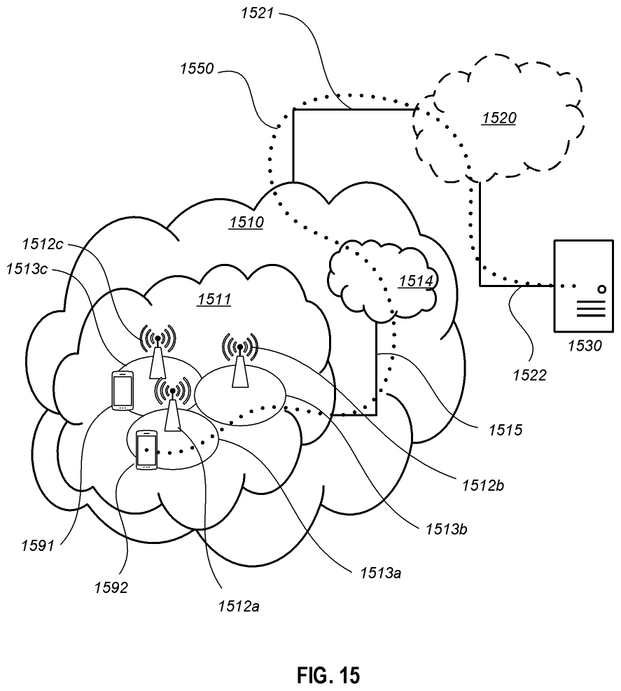

With reference to FIG. 15, in accordance with an embodiment, a communication system includes a telecommunication network 1510, such as a 3GPP-type cellular network, which comprises an access network 1511, such as a radio access network, and a core network 1514. The access network 1511 comprises a plurality of base stations 1512a, 1512b, 1512c, such as NBs, eNBs, gNBs or other types of wireless access points, each defining a corresponding coverage area 1513a, 1513b, 1513c. Each base station 1512a, 1512b, 1512c is connectable to the core network 1514 over a wired or wireless connection 1515. A first user equipment (UE) 1591 located in coverage area 1513c is configured to wirelessly connect to, or be paged by, the corresponding base station 1512c. A second UE 1592 in coverage area 1513a is wirelessly connectable to the corresponding base station 1512a. While a plurality of UEs 1591, 1592 are illustrated in this example, the disclosed embodiments are equally applicable to a situation where a sole UE is in the coverage area or where a sole UE is connecting to the corresponding base station 1512.

The telecommunication network 1510 is itself connected to a host computer 1530, which may be embodied in the hardware and/or software of a standalone server, a cloud-implemented server, a distributed server or as processing resources in a server farm. The host computer 1530 may be under the ownership or control of a service provider, or may be operated by the service provider or on behalf of the service provider. The connections 1521, 1522 between the telecommunication network 1510 and the host computer 1530 may extend directly from the core network 1514 to the host computer 1530 or may go via an optional intermediate network 1520. The intermediate network 1520 may be one of, or a combination of more than one of, a public, private or hosted network; the intermediate network 1520, if any, may be a backbone network or the Internet; in particular, the intermediate network 1520 may comprise two or more sub-networks (not shown).

The communication system of FIG. 15 as a whole enables connectivity between one of the connected UEs 1591, 1592 and the host computer 1530. The connectivity may be described as an over-the-top (OTT) connection 1550. The host computer 1530 and the connected UEs 1591, 1592 are configured to communicate data and/or signaling via the OTT connection 1550, using the access network 1511, the core network 1514, any intermediate network 1520 and possible further infrastructure (not shown) as intermediaries. The OTT connection 1550 may be transparent in the sense that the participating communication devices through which the OTT connection 1550 passes are unaware of routing of uplink and downlink communications. For example, a base station 1512 may not or need not be informed about the past routing of an incoming downlink communication with data originating from a host computer 1530 to be forwarded (e.g., handed over) to a connected UE 1591. Similarly, the base station 1512 need not be aware of the future routing of an outgoing uplink communication originating from the UE 1591 towards the host computer 1530.

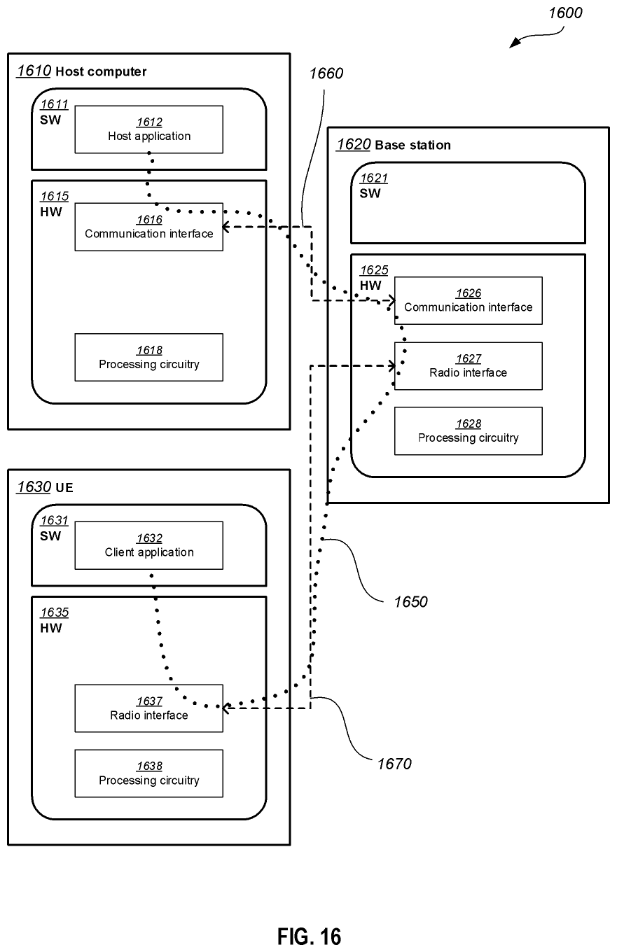

Example implementations, in accordance with an embodiment, of the UE, base station and host computer discussed in the preceding paragraphs will now be described with reference to FIG. 16. In a communication system 1600, a host computer 1610 comprises hardware 1615 including a communication interface 1616 configured to set up and maintain a wired or wireless connection with an interface of a different communication device of the communication system 1600. The host computer 1610 further comprises processing circuitry 1618, which may have storage and/or processing capabilities. In particular, the processing circuitry 1618 may comprise one or more programmable processors, application-specific integrated circuits, field programmable gate arrays or combinations of these (not shown) adapted to execute instructions. The host computer 1610 further comprises software 1611, which is stored in or accessible by the host computer 1610 and executable by the processing circuitry 1618. The software 1611 includes a host application 1612. The host application 1612 may be operable to provide a service to a remote user, such as a UE 1630 connecting via an OTT connection 1650 terminating at the UE 1630 and the host computer 1610. In providing the service to the remote user, the host application 1612 may provide user data which is transmitted using the OTT connection 1650.

The communication system 1600 further includes a base station 1620 provided in a telecommunication system and comprising hardware 1625 enabling it to communicate with the host computer 1610 and with the UE 1630. The hardware 1625 may include a communication interface 1626 for setting up and maintaining a wired or wireless connection with an interface of a different communication device of the communication system 1600, as well as a radio interface 1627 for setting up and maintaining at least a wireless connection 1670 with a UE 1630 located in a coverage area (not shown in FIG. 16) served by the base station 1620. The communication interface 1626 may be configured to facilitate a connection 1660 to the host computer 1610. The connection 1660 may be direct or it may pass through a core network (not shown in FIG. 16) of the telecommunication system and/or through one or more intermediate networks outside the telecommunication system. In the embodiment shown, the hardware 1625 of the base station 1620 further includes processing circuitry 1628, which may comprise one or more programmable processors, application-specific integrated circuits, field programmable gate arrays or combinations of these (not shown) adapted to execute instructions. The base station 1620 further has software 1621 stored internally or accessible via an external connection.

The communication system 1600 further includes the UE 1630 already referred to. Its hardware 1635 may include a radio interface 1637 configured to set up and maintain a wireless connection 1670 with a base station serving a coverage area in which the UE 1630 is currently located. The hardware 1635 of the UE 1630 further includes processing circuitry 1638, which may comprise one or more programmable processors, application-specific integrated circuits, field programmable gate arrays or combinations of these (not shown) adapted to execute instructions. The UE 1630 further comprises software 1631, which is stored in or accessible by the UE 1630 and executable by the processing circuitry 1638. The software 1631 includes a client application 1632. The client application 1632 may be operable to provide a service to a human or non-human user via the UE 1630, with the support of the host computer 1610. In the host computer 1610, an executing host application 1612 may communicate with the executing client application 1632 via the OTT connection 1650 terminating at the UE 1630 and the host computer 1610. In providing the service to the user, the client application 1632 may receive request data from the host application 1612 and provide user data in response to the request data. The OTT connection 1650 may transfer both the request data and the user data. The client application 1632 may interact with the user to generate the user data that it provides.

It is noted that the host computer 1610, base station 1620 and UE 1630 illustrated in FIG. 16 may be identical to the host computer 1530, one of the base stations 1512a, 1512b, 1512c and one of the UEs 1591, 1592 of FIG. 15, respectively. This is to say, the inner workings of these entities may be as shown in FIG. 16 and independently, the surrounding network topology may be that of FIG. 15.

In FIG. 16, the OTT connection 1650 has been drawn abstractly to illustrate the communication between the host computer 1610 and the use equipment 1630 via the base station 1620, without explicit reference to any intermediary devices and the precise routing of messages via these devices. Network infrastructure may determine the routing, which it may be configured to hide from the UE 1630 or from the service provider operating the host computer 1610, or both. While the OTT connection 1650 is active, the network infrastructure may further take decisions by which it dynamically changes the routing (e.g., on the basis of load balancing consideration or reconfiguration of the network).

The wireless connection 1670 between the UE 1630 and the base station 1620 is in accordance with the teachings of the embodiments described throughout this disclosure. One or more of the various embodiments improve the performance of OTT services provided to the UE 1630 using the OTT connection 1650, in which the wireless connection 1670 forms the last segment. More precisely, the teachings of these embodiments may improve the power consumption and thereby provide benefits such as extended battery lifetime.

A measurement procedure may be provided for the purpose of monitoring data rate, latency and other factors on which the one or more embodiments improve. There may further be an optional network functionality for reconfiguring the OTT connection 1650 between the host computer 1610 and UE 1630, in response to variations in the measurement results. The measurement procedure and/or the network functionality for reconfiguring the OTT connection 1650 may be implemented in the software 1611 of the host computer 1610 or in the software 1631 of the UE 1630, or both. In embodiments, sensors (not shown) may be deployed in or in association with communication devices through which the OTT connection 1650 passes; the sensors may participate in the measurement procedure by supplying values of the monitored quantities exemplified above, or supplying values of other physical quantities from which software 1611, 1631 may compute or estimate the monitored quantities. The reconfiguring of the OTT connection 1650 may include message format, retransmission settings, preferred routing etc.; the reconfiguring need not affect the base station 1620, and it may be unknown or imperceptible to the base station 1620. Such procedures and functionalities may be known and practiced in the art. In certain embodiments, measurements may involve proprietary UE signaling facilitating the host computer's 1610 measurements of throughput, propagation times, latency and the like. The measurements may be implemented in that the software 1611, 1631 causes messages to be transmitted, in particular empty or ‘dummy’ messages, using the OTT connection 1650 while it monitors propagation times, errors etc.

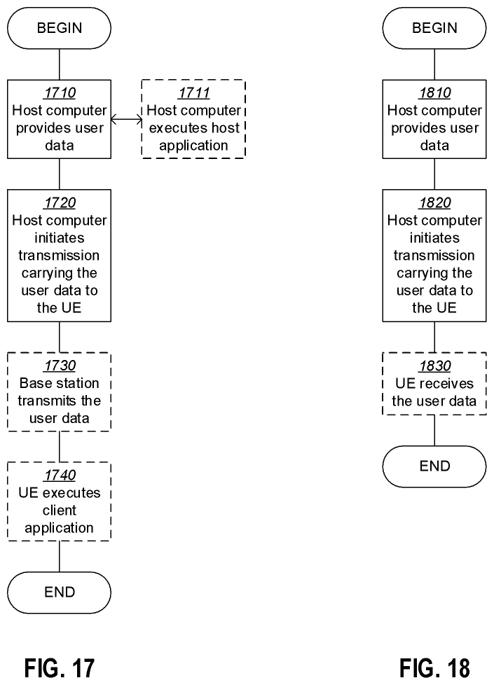

FIG. 17 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 17 will be included in this section. In a first step 1710 of the method, the host computer provides user data. In an optional substep 1711 of the first step 1710, the host computer provides the user data by executing a host application. In a second step 1720, the host computer initiates a transmission carrying the user data to the UE. In an optional third step 1730, the base station transmits to the UE the user data which was carried in the transmission that the host computer initiated, in accordance with the teachings of the embodiments described throughout this disclosure. In an optional fourth step 1740, the UE executes a client application associated with the host application executed by the host computer.

FIG. 18 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 18 will be included in this section. In a first step 1810 of the method, the host computer provides user data. In an optional substep (not shown) the host computer provides the user data by executing a host application.

In a second step 1820, the host computer initiates a transmission carrying the user data to the UE. The transmission may pass via the base station, in accordance with the teachings of the embodiments described throughout this disclosure. In an optional third step 1830, the UE receives the user data carried in the transmission.

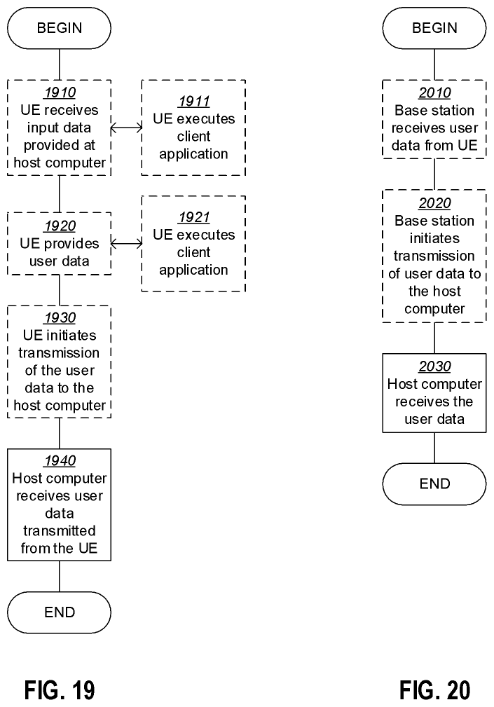

FIG. 19 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 19 will be included in this section. In an optional first step 1910 of the method, the UE receives input data provided by the host computer. Additionally or alternatively, in an optional second step 1920, the UE provides user data. In an optional substep 1921 of the second step 1920, the UE provides the user data by executing a client application. In a further optional substep 1911 of the first step 1910, the UE executes a client application which provides the user data in reaction to the received input data provided by the host computer. In providing the user data, the executed client application may further consider user input received from the user. Regardless of the specific manner in which the user data was provided, the UE initiates, in an optional third substep 1930, transmission of the user data to the host computer. In a fourth step 1940 of the method, the host computer receives the user data transmitted from the UE, in accordance with the teachings of the embodiments described throughout this disclosure.

FIG. 20 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 20 will be included in this section. In an optional first step 2010 of the method, in accordance with the teachings of the embodiments described throughout this disclosure, the base station receives user data from the UE. In an optional second step 2020, the base station initiates transmission of the received user data to the host computer. In a third step 2030, the host computer receives the user data carried in the transmission initiated by the base station.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

1. A method performed by a Radio Unit, RU, comprising:
receiving, from a Digital Unit, DU, an instruction to receive a reference signal;
receiving, from a terminal device, the reference signal in accordance with the instruction; and
transmitting, to the DU, a positioning signal based on the received reference signal.

2. The method of claim 1, further comprising:
determining an absolute position of the RU, or a relative position of the RU in relation to another RU; and
transmitting the absolute position or relative position of the RU to the DU.

3. The method of claim 2, wherein the absolute position of the RU is determined by means of satellite-based positioning.

4. The method of claim 2, wherein the relative position of the RU is determined by means of one or more of: laser positioning, path-loss measurement, or time-difference measurement, between the RU and the other RU.

5. The method of claim 1, further comprising:
determining an absolute position of another RU, or a relative position of the other RU in relation to the RU; and
transmitting the absolute position or relative position of the other RU to the other RU to the DU.

6. The method of claim 1, wherein the positioning signal indicates one or more of: time at which the reference signal is received at the RU, and/or an amplitude and a phase of the received reference signal.

7. The method of claim 1, further comprising:
transmitting, to a further RU, a request for a configuration of the reference signal; and
receiving the configuration from the further RU.

8. The method of claim 1, further comprising:
transmitting, to a further RU, a configuration of the reference signal.

9. The method of claim 7, wherein the configuration comprises a timing and/or a radio resource for the reference signal.

10. The method of claim 7, wherein the further RU is configured for data communication and associated signaling, and the RU is dedicated to positioning.

11. A method performed by a Digital Unit, DU, comprising:
transmitting, to a Radio Unit, RU, an instruction to receive a reference signal;
transmitting, to a terminal device via a further RU, an instruction to transmit the reference signal;
receiving, from the RU, a positioning signal based on the received reference signal; and
determining a position of the terminal device based on the positioning signal.

12. The method of claim 11, further comprising:
receiving, from the RU, an absolute position of the RU, or a relative position of the RU in relation to another RU.

13. The method of claim 12, wherein the position of the terminal device is determined further based on the absolute position or relative position of the RU.

14. The method of claim 11, further comprising:
receiving, from the RU, an absolute position of another RU, or a relative position of the other RU in relation to the RU.

15. The method of claim 11, wherein the positioning signal indicates one or more of: time at which the reference signal is received at the RU, and/or an amplitude and a phase of the received reference signal.

16. The method of claim 11, further comprising:
forwarding a request for a configuration of the reference signal from the RU to the further RU; and
forwarding the configuration from the further RU to the RU.

17. The method of claim 11, further comprising:
forwarding a configuration of the reference signal from the RU to the further RU.

18. The method of claim 16, wherein the configuration comprises a timing and/or a radio resource for the reference signal.

19. The method of claim 16, further comprising:
transmitting, to the further RU, information indicating the determined position of the terminal device.

20. (canceled)

21. A method performed by a Radio Unit, RU, comprising:
receiving, from a Digital Unit, DU, an instruction to transmit a reference signal; and
transmitting, to a terminal device, the reference signal in accordance with the instruction.

22-49. (canceled)
